(19) United States
(12) Patent Application Publication
(10) Pub. No.: US 2013/0228500 A1
(43) Pub. Date: Sep. 5, 2013

(54) Apparatus for water treatment using filtration or a membrane separation method

(71) Applicant: Siegfried Egner, Adelsheim (DE)

(72) Inventor: Siegfried Egner, Adelsheim (DE)

(73) Assignee: Fraunhofer-Gesellschaft zur Forderung der angewandten Forschung e.V., Munchen (DE)

(21) Appl. No.: 13/880,379

(22) PCT Filed: Oct. 18, 2011
(86) PCT No.: PCT/EP2011/068179

§ 371 Date: Apr. 19, 2013

(30) Foreign Application Priority Data
Oct. 20, 2010 (DE) 10 2010 049 076.8
Mar. 2, 2011 (DE) 10 2011 012 832.8

(51) Int. Cl. C02F 1/467

(52) U.S. Cl. CPC C02F 1/4672
USPC 210/192

(57) ABSTRACT

An apparatus for water treatment is proposed that comprises a means for mechanical separation constructed as a membrane (12) or filter surface, such that the means for mechanical separation is constructed as an anode and a cathode (18) is arranged at a distance therefrom.

The invention concerns an apparatus for water treatment by means of filtration or membrane separation method.

For treating raw water, process water or wastewater, different methods in separate processing stages are used. Known is mechanical cleaning by filtration or a membrane separation method. In filters that are used in dead-end operation but also on membranes that are operated in so-called cross flow, a cover layer is formed over time. This cover layer impairs the functionality of the filter or membrane and must be removed with high energetic and apparatus-technological expenditure. Partially, the cover layer formations are irreversible so that a removal is not possible and the entire membrane must be exchanged. Moreover, the membranes or filters tend to experience microbial contamination by microorganisms such as algae or bacteria so that chemicals that form undesirable by-products must be used for disinfection.

As a further processing stage a chemical treatment of the raw water, process water or wastewater by electrolytic oxidation is carried out. In this context, by electrochemical processes substances that act as disinfectant are generated from the water itself or from its natural ingredients. By electrolysis, water is split into the elements oxygen and hydrogen. In side reactions, disinfectant substances such as ozone (O₃) and OH radicals are formed at the anode and hydrogen peroxide (H₂O₂) at the cathode. In addition, disinfectant components are formed by conversion of the chloride ions (Cl⁻) that are contained naturally in the drinking water to hypochloric acid (HOCl) or hypochlorite ions (ClO⁻).

The invention has the object to provide an improved method for treatment of drinking water and process water.

The invention is based on the idea of producing a membrane of an inert conductive material so that it can be used for mechanical separation methods as well as an anode for formation of hydroxyl radicals and reactive oxygen by electrolytic oxidation. In this way, in accordance with the invention an advantageous possibility is provided to combine membrane separation methods and chemical purification methods in water treatment. In this way, facilities and apparatus can be designed more compact, more energy-efficient and more cost-efficient.

It is particularly beneficial when the membrane is produced of ceramic, polymeric or metallic materials. Ceramic or polymeric materials are in general chemically inert and can be made conducting, for example, by admixture of conducting components to the starting material in a simple way. The invention can be realized even more simply when the membrane is produced, for example, of metallic materials, for example, foils. They are inherently conducting.

An advantageous embodiment of the invention provides that an anode is arranged at a permeate side. In this way, the oxidation agents which are formed preferably at the anode, for example, hypochlorite ions, ozone or hydroxide radicals, are directly formed in the medium to be oxidized and the two process steps of the mechanical separation, on the one hand, and of the electrolytic oxidation, on the other hand, are combined in an advantageous way. Accordingly, the apparatus of water treatment can be constructed to be more compact, more energy-efficient and more cost-efficient.

Moreover, it is proposed that the cathode is arranged on a retentate side. Accordingly, the oxidation agents are preferably formed in the feed stream and act thus on the membrane surface. Because of the oxidizing and thus also disinfecting action, microbiological activities on or in the membrane are prevented. Back-flushing for removal of a microbial cover layer, combined with high flow velocities that require an appropriately high energetic and apparatus expenditure are not required. In particular, an irreversible blocking of ceramic membranes with algae, for example, in seawater desalination is reduced. Irreversible means in this context that the a cover layer is formed by the algae growth on the membrane surface that cannot be removed by back-flushing or by addition of appropriate chemicals and therefore forces the premature exchange of the membrane. Accordingly, with the arrangement according to the invention the membrane becomes utilizable for a longer period of time.

A further advantageous embodiment resides in that the cathode is arranged at the feed or retentate side and a second cathode at the permeate side. In this way, electrical fields for generating disinfectant substances can be formed without great constructive or financial expenditure simultaneously at the retentate side and the permeate side. With the arrangement according to the invention, the retentate the permeate, and the membrane are simultaneously disinfected. Accordingly, the costs for a separate apparatus for disinfection of permeate or retentate are saved

Moreover, it is proposed to design an apparatus for water treatment comprising a filter surface, operated in as dead-end filtration in such a way that the filter surface is embodied as an anode. In this way, the filter surface combines two essential functions for the water treatment. On the one hand, it serves as a filter medium during filtration; on the other hand, it can be used as an anode for electrolytic disinfection. Accordingly, the mechanical purification of the wastewater by filtration and a chemical treatment by electrolytic oxidation can be combined advantageously in one apparatus so that the facilities for water treatment become more compact and cost-efficient.

A manufacturing-technologically simple solution is provided when the filter surface is produced of paper or fabric. Paper or fabric of natural fibers or synthetic fibers are in general inert and the introduction of conductive fibers can be effected in a simple way.

An advantageous embodiment of the invention provides that a cathode is arranged on a filtrate side. Accordingly, the oxidizing substances required for disinfection are formed by electrolysis directly in the medium to be disinfected and from the medium. Accordingly, the addition of dangerous chemicals that possibly may form poisonous by-products can be eliminated. Moreover, a complex facility technology as it is required, for example, for ozone treatment of drinking water is also not needed.

A further advantageous embodiment of the apparatus according to the invention provides that the cathode is arranged on a feed side. Accordingly, the oxidizing substances that are formed by electrolysis act on in the filter surface or in the filter cake and can immediately destroy thereat hazardous substances or microorganisms so that the danger of filter passage is minimized.

Moreover, it is proposed that the cathode is arranged on the feed side and a second cathode at the filtrate side. In this way, electrical fields for generating disinfectant substances can be formed without great constructive or financial expenditure simultaneously at the feed side and the filtrate side. With the arrangement according to the invention, the filter cake, the filtrate and the filter are simultaneously disinfected. In this way, the costs for a separate apparatus for disinfection of filtrate or filter cake are saved.

It is particularly beneficial when the anode is embodied to be inert with a surface of platinum or diamond. In the electrolysis of water anodes with such surfaces are characterized in that a particularly large quantity of oxidizing substances is formed on them. In particular, on diamond surfaces preferably hydroxide radicals (OH) are formed. These hydroxide radicals are extremely reactive and represent therefore a very good disinfectant agent.

It is moreover beneficial when a sacrificial anode is arranged in the flow direction upstream or downstream of the membrane or the filter surface and is constructively connected therewith. By using non-inert materials for the anode, for example, iron or aluminum, hydroxide flakes can be formed by electrolysis in a targeted fashion. These chemicals are suitable for targeted water treatment. For example, iron hydroxide has a decomposition-inhibiting action while aluminum hydroxide acts as a phosphate binder.

Further advantages and advantageous embodiments can be taken from the following drawings, their description, and the claims. All features disclosed in the drawings, their description, and the claims can be important for the invention individually as well as in combination with each other.

The drawings show in schematic illustration in:

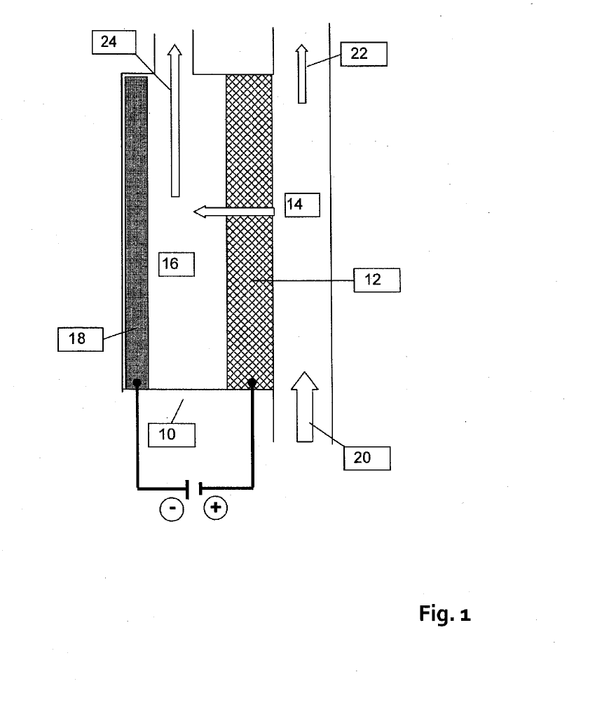

FIG. 1 an embodiment of the invention in a first arrangement for membrane separation methods,

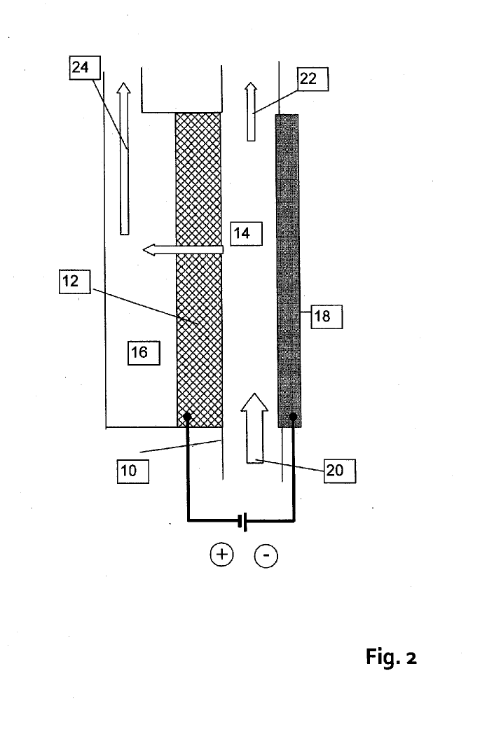

FIG. 2 a second arrangement for membrane separation methods,

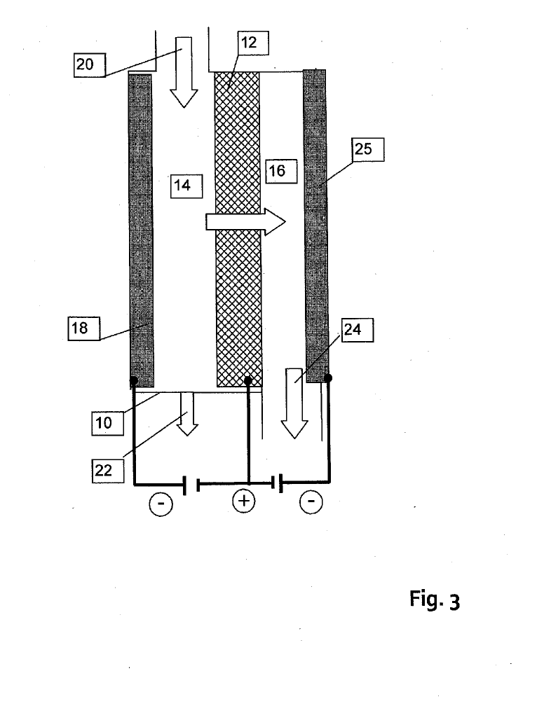

FIG. 3 a third arrangement for membrane separation methods

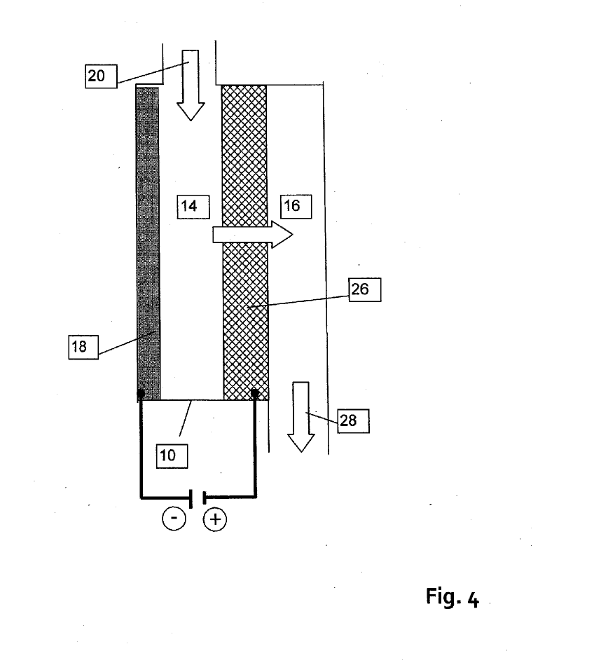

FIG. 4 a second embodiment of the invention in a first arrangement for filtration methods,

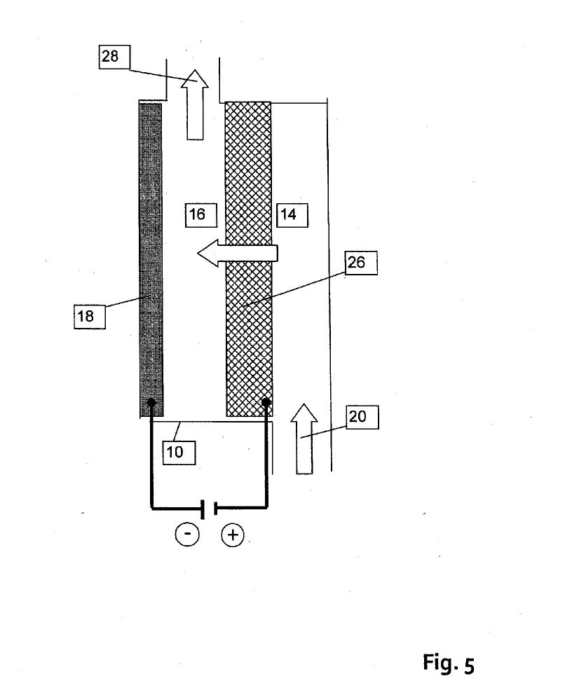

FIG. 5 a second arrangement for filtration methods, and

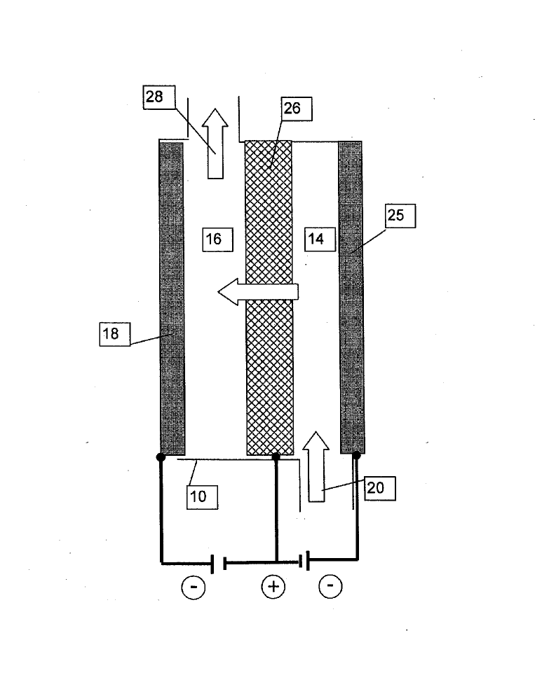

FIG. 6 a third arrangement for filtration methods.

FIG. 1 shows a first example of application of the invention for a membrane separation method. Illustrated is in a schematic illustration a housing 10 of an apparatus for water treatment. Arranged therein is a membrane 12 embodied as an anode and separating a feed or retentate 14 of the apparatus from an outflow side 16. At the outflow side 16 a cathode 18 is arranged.

The liquid that is supplied as feed 20 passes through the membrane 12. In doing so, the substances to be separated are retained at the feed side 14 and are concentrated thereat and removed as a retentate 22. At the same time, an electrical direct current or alternating current applied between the cathode 18 and anode leads to the formation of oxidizing or disinfectant substances on the basis of oxygen or chlorine. In the process, water is split by electrochemical reaction into the elements oxygen and hydrogen. As by-products, ozone (O₃) and OH radicals are generated at the anode 18; at the cathode 12 hydrogen peroxide (H₂O₂). These substances have a disinfectant action. Native chloride ions (Cl⁻) that are contained in the water react with direct current to hypochloric acid (HOCl) or hypochlorite ions (ClO⁻) which also act disinfectantly.

The substances that are formed in this way pass directly into the water to be treated at the feed side 14 and purified water 24 exits the apparatus at the outflow side 16.

The kind and quantity of oxidizing or disinfectant substances depend inter alia on the employed anode material and the ingredients of the water.

FIG. 2 shows a second arrangement according to the invention for membrane separation methods wherein the cathode 18 is arranged at the feed side 14. In this connection, the oxidizing or disinfectant substances are formed at the feed side 14 and effect thereat oxidation or disinfection of the retentate 22 and the surface of the cathode 12.

In FIG. 3, a third arrangement according to the invention for membrane separation methods is illustrated. In this context, a cathode 18 is arranged at the feed side or retentate side 14 and a second cathode 25 at the permeate side 16. Between them, the membrane 12 that is embodied as an anode is arranged. By applying an electrical direct current or alternating current, between the cathodes 18 and 25 and the anode 12 an electrical field is generated and under its effect the disinfectant substances are formed. With the arrangement according to the invention the substances are formed at the permeate side 16 as well as at the retentate side 14. In this way, the disinfection and oxidation of retentate 22, membrane surface and permeate 24 are performed simultaneously.

In FIG. 4, an example of application of the invention for filtration methods is illustrated. In this context, a filter surface 26 is embodied as an anode. The filter surface 26 separates in the housing 10 the feed side 14 from the outflow side 16. The cathode 18 is arranged at the feed side 14. The liquid that is supplied as feed 20 passes through the filter surface 26. The substances that are entrained in the feed 20 are separated at the filter surface 26 and form successively a filter cake (not illustrated). A filtrate 28 exits the housing 10 at the outflow side 16. Between cathode 18 and the filter surface 26 embodied as an anode, disinfectant and oxidizing substances are formed by application of a direct current in accordance with the identical mechanism as in the previously described membrane separation methods.

They inhibit biological activities in the filter cake and decompose harmful substances in the filter surface 26 or the filter cake.

FIG. 5 shows a second arrangement according to the invention for filtration methods. The anode 18 is arranged on the outflow side 16. The oxidizing and disinfectant substances are formed in the filtrate 28 and act thereat such that disinfected, oxidized filtrate 28 is discharged.

In FIG. 6, a third arrangement of the invention for filtration methods is illustrated. A cathode 18 is arranged at the feed side 14 and a second cathode 25 at the filtrate side 16. Between them, the filter surface 26 is arranged that is embodied as an anode. By applying an electrical direct current or alternating current between the cathode 18 and 25 and the anode 26, an electrical field is generated and under its effect the disinfectant substances are formed. With the arrangement according to the invention, the substances are formed at the filtrate side 16 as well as at the feed side 14. Accordingly, the disinfection and oxidation of filter cake, filter surface 26 and filtrate is carried out simultaneously

What is claimed is:

1.-12. (canceled)

13. An apparatus for water treatment, the apparatus operated in cross-flow filtration, the apparatus comprising:
a membrane;
a first cathode arranged at a spacing relative to the membrane;
wherein the membrane is embodied as an anode and generates with the first cathode an electrical field upon application of direct current or alternating current to the first cathode and the anode.

14. The apparatus according to claim 13, wherein the membrane is produced of a material selected from the group consisting of a ceramic, a polymer or a metallic material.

15. The apparatus according to claim 13, wherein the first cathode is arranged at a permeate side of the apparatus.

16. The apparatus according to claim 13, wherein the first cathode is arranged at a retentate side of the apparatus.

17. The apparatus according to claim 13, wherein the first cathode is arranged at a retentate side of the apparatus and a second cathode is arranged at a permeate side of the apparatus.

18. The apparatus according to claim 13, wherein the first cathode is embodied to be inert.

19. The apparatus according to claim 13, wherein the first cathode has a surface of platinum or diamond.

20. The apparatus according to claim 13, further comprising a sacrificial anode that is arranged in a flow direction upstream or downstream of the membrane and is constructively connected to the membrane.

21. An apparatus for water treatment, the apparatus operated in dead-end filtration, the apparatus comprising:
a filter surface;
a first cathode arranged at a spacing relative to the filter surface;
wherein the filter surface is embodied as an anode and generates an electrical field with the first cathode upon application of direct current or alternating current to the first cathode and the anode.

22. The apparatus according to claim 21, wherein the filter surface is made of paper or fabric.

23. The apparatus according to claim 21, wherein the first cathode is arranged at a filtrate side of the apparatus.

24. The apparatus according to claim 21, wherein the first cathode is arranged at a feed side of the apparatus.

25. The apparatus according to claim 21, wherein the first cathode is arranged at a feed side of the apparatus and a second cathode is arranged at a filtrate side of the apparatus.

26. The apparatus according to claim 21, wherein the first cathode is embodied to be inert.

27. The apparatus according to claim 21, wherein the first cathode has a surface of platinum or diamond.

28. The apparatus according to claim 21, further comprising a sacrificial anode that is arranged in a flow direction upstream or downstream of the filter surface and is constructively connected to the filter surface.
